(19) United States
(12) Patent Application Publication
(10) Pub. No.: US 2025/0176003 A1
(43) Pub. Date: May 29, 2025

(54) BROADCAST CONFIGURATIONS FOR REDUCED CAPABILITY USER EQUIPMENT

(71) Applicant: QUALCOMM Incorporated, San Diego, CA (US)

(72) Inventors: Le LIU, San Jose, CA (US); Alberto RICO ALVARINO, San Diego, CA (US); Peter GAAL, San Diego, CA (US); Prasada Veera Reddy KADIRI, San Diego, CA (US); Kazuki TAKEDA, Minato-ku, Tokyo (JP); Miguel GRIOT, La Jolla, CA (US); Linhai HE, San Diego, CA (US); Haris ZISIMOPOULOS, London (GB); Jing LEI, San Diego, CA (US); Juan MONTOJO, San Diego, CA (US)

(21) Appl. No.: 18/836,976

(22) PCT Filed: Mar. 22, 2023
(86) PCT No.: PCT/US2023/015863

§ 371 Date: Aug. 8, 2024

(30) Foreign Application Priority Data
Apr. 28, 2022 (GR) 20220100352

(51) Int. Cl. H04W 72/51; H04L 5/00; H04W 72/0453; H04W 72/30

(52) U.S. Cl. CPC H04W 72/51; H04L 5/0053; H04W 72/0453; H04W 72/30

(57) ABSTRACT

Various aspects of the present disclosure generally relate to wireless communication. In some aspects, a user equipment (UE) may transmit an indication that the UE is a reduced capability (RedCap) UE associated with a maximum reception bandwidth. The UE may receive a configuration of one or more common frequency resources (CFRs) associated with one or more broadcast communications, wherein the configuration of the one or more CFRs is based at least in part on the indication that the UE is the RedCap UE associated with the maximum reception bandwidth. Numerous other aspects are described.

### CROSS-REFERENCE TO RELATED APPLICATION

This Patent Application claims priority to Greek patent application Ser. No. 20/220,100352, filed on Apr. 28, 2022, entitled “BROADCAST CONFIGURATIONS FOR REDUCED CAPABILITY USER EQUIPMENT,” which is hereby expressly incorporated by reference herein.

### FIELD OF THE DISCLOSURE

Aspects of the present disclosure generally relate to wireless communication and to techniques and apparatuses for broadcast configuration for reduced capability user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support

communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an indication that the UE is a reduced capability (RedCap) UE associated with a maximum reception bandwidth. The method may include receiving a configuration of one or more common frequency resources (CFRs) associated with one or more broadcast communications, wherein the configuration of the one or more CFRs is based at least in part on the indication that the UE is the RedCap UE associated with the maximum reception bandwidth.

Some aspects described herein relate to a method of wireless communication performed by a network entity. The method may include receiving, from a UE, an indication that the UE is a RedCap UE associated with a maximum reception bandwidth. The method may include transmitting, to the UE, a configuration of one or more CFRs associated with one or more broadcast communications, wherein the configuration of the one or more CFRs is based at least in part on the indication that the UE is the RedCap UE associated with the maximum reception bandwidth.

Some aspects described herein relate to an apparatus for wireless communication at a UE. The apparatus may include a memory and one or more processors coupled to the memory. The one or more processors may be configured to transmit an indication that the UE is a RedCap UE associated with a maximum reception bandwidth. The one or more processors may be configured to receive a configuration of one or more CFRs associated with one or more broadcast communications, wherein the configuration of the one or more CFRs is based at least in part on the indication that the UE is the RedCap UE associated with the maximum reception bandwidth.

Some aspects described herein relate to an apparatus for wireless communication at a network entity. The network entity may include a memory and one or more processors coupled to the memory. The one or more processors may be configured to receive, from a UE, an indication that the UE is a RedCap UE associated with a maximum reception bandwidth. The one or more processors may be configured to transmit, to the UE, a configuration of one or more CFRs associated with one or more broadcast communications, wherein the configuration of the one or more CFRs is based at least in part on the indication that the UE is the RedCap UE associated with the maximum reception bandwidth.

Some aspects described herein relate to a non-transitory computer-readable medium that stores a set of instructions for wireless communication by a UE. The set of instructions, when executed by one or more processors of the UE, may cause the UE to transmit an indication that the UE is a RedCap UE associated with a maximum reception bandwidth. The set of instructions, when executed by one or more processors of the UE, may cause the UE to receive a configuration of one or more CFRs associated with one or more broadcast communications, wherein the configuration of the one or more CFRs is based at least in part on the indication that the UE is the RedCap UE associated with the maximum reception bandwidth.

Some aspects described herein relate to a non-transitory computer-readable medium that stores a set of instructions for wireless communication by a network entity. The set of instructions, when executed by one or more processors of the network entity, may cause the network entity to receive, from a UE, an indication that the UE is a RedCap UE associated with a maximum reception bandwidth. The set of instructions, when executed by one or more processors of the network entity, may cause the network entity to transmit, to the UE, a configuration of one or more CFRs associated with one or more broadcast communications, wherein the configuration of the one or more CFRs is based at least in part on the indication that the UE is the RedCap UE associated with the maximum reception bandwidth.

Some aspects described herein relate to an apparatus for wireless communication. The apparatus may include means for transmitting an indication that the apparatus is a RedCap apparatus associated with a maximum reception bandwidth. The apparatus may include means for receiving a configuration of one or more CFRs associated with one or more broadcast communications, wherein the configuration of the one or more CFRs is based at least in part on the indication that the apparatus is the RedCap apparatus associated with the maximum reception bandwidth.

Some aspects described herein relate to an apparatus for wireless communication. The apparatus may include means for receiving, from a UE, an indication that the UE is a RedCap UE associated with a maximum reception bandwidth. The apparatus may include means for transmitting, to the UE, a configuration of one or more CFRs associated with one or more broadcast communications, wherein the configuration of the one or more CFRs is based at least in part on the indication that the UE is the RedCap UE associated with the maximum reception bandwidth.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network architecture, in accordance with the present disclosure.

FIG. 4 is a diagram illustrating an example resource structure for wireless communication, in accordance with the present disclosure.

FIG. 5 is a diagram illustrating an example of common frequency resource structures for broadcast communications, in accordance with the present disclosure.

FIGS. 6-9 are diagrams of examples associated with broadcast configurations for reduced capability (RedCap) UEs, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

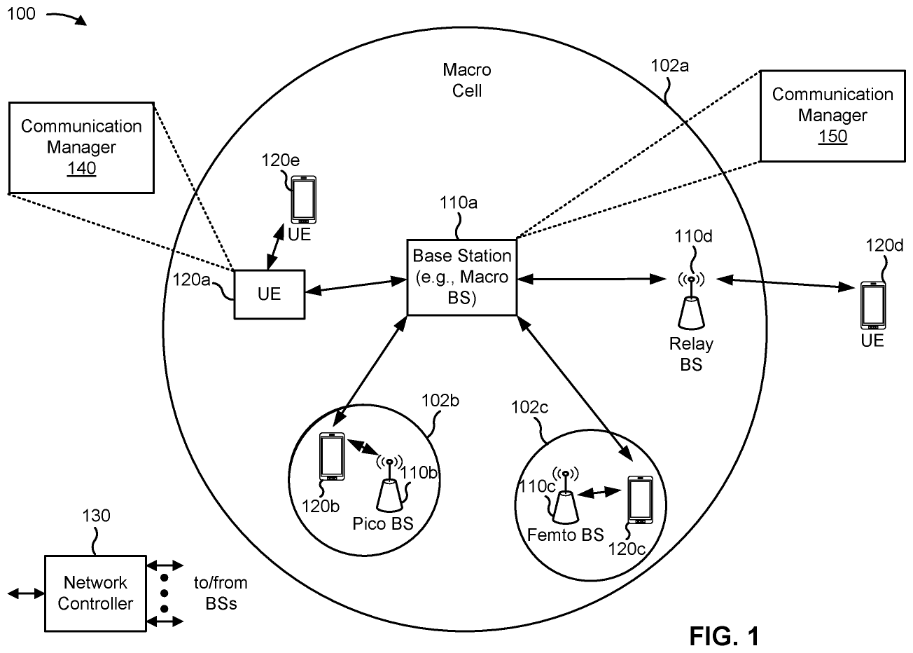

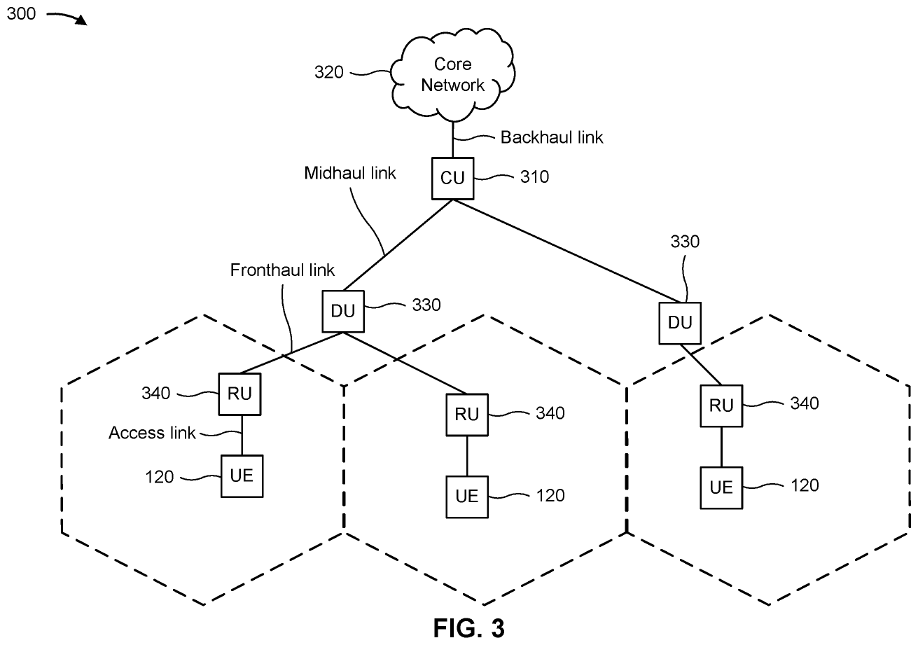

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although the base station 110 is shown as an integral unit in FIG. 1, aspects of the disclosure are not so limited. In some other aspects, the functionality of the base station 110 may be disaggregated according to an open radio access network (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, an indication that the UE is a reduced capability (RedCap) UE associated with a maximum reception bandwidth; and receive, from the network entity, a configuration of one or more common frequency resources (CFRs) associated with one or more broadcast communications, wherein the configuration of the one or more CFRs is based at least in part on the indication that the UE is the RedCap UE associated with the maximum reception bandwidth. Additionally, or alternatively, the communication manager 140 may perform one or more other operations described herein.

In some aspects, the network entity describe elsewhere herein may correspond to the base station 110. The network entity may include a communication manager 150. As described in more detail elsewhere herein, the communication manager 150 may receive, from a UE (e.g., UE 120), an indication that the UE is a RedCap UE associated with a maximum reception bandwidth; and transmit, to the UE, a configuration of one or more CFRs associated with one or more broadcast communications, wherein the configuration of the one or more CFRs is based at least in part on the indication that the UE is the RedCap UE associated with the maximum reception bandwidth. Additionally, or alternatively, the communication manager 150 may perform one or more other operations described herein.

As indicated above, FIG. 1 is provided as an example. Other examples may differ from what is described with regard to FIG. 1.

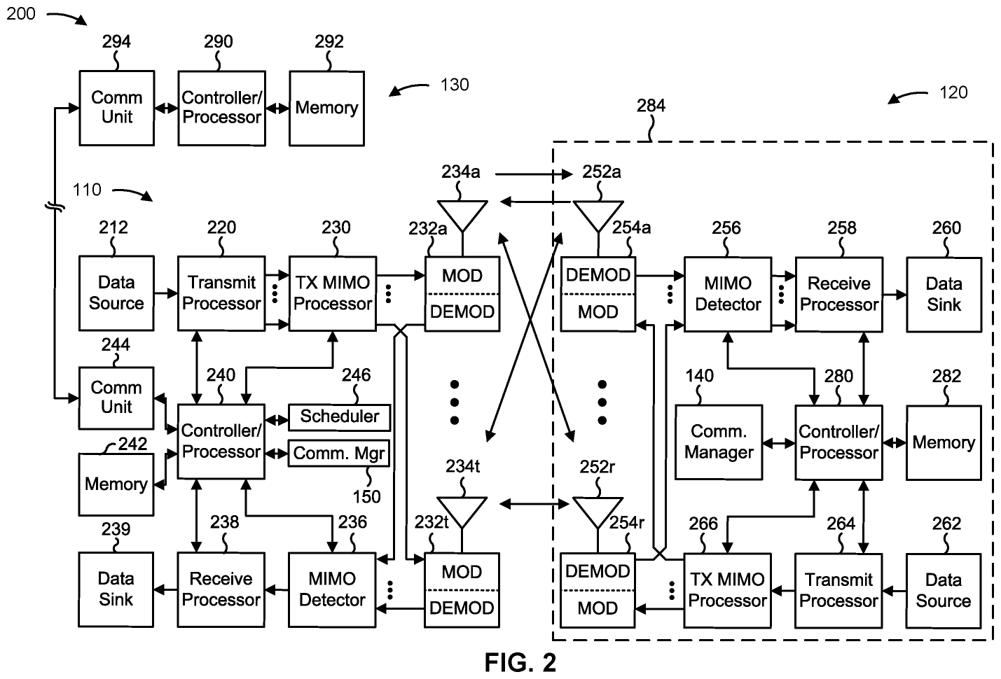

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

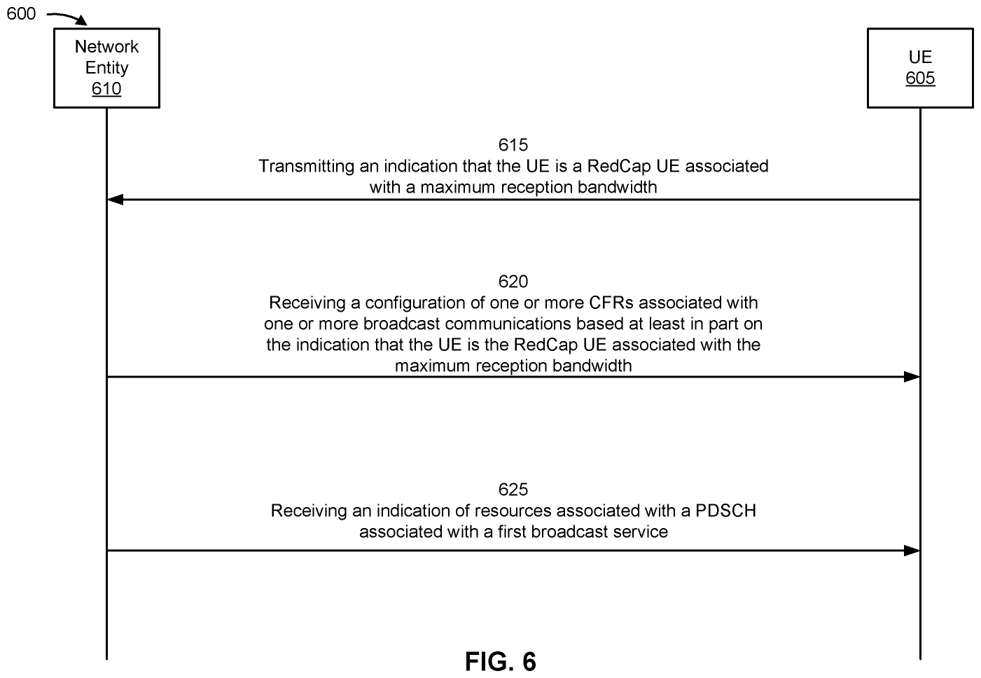

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

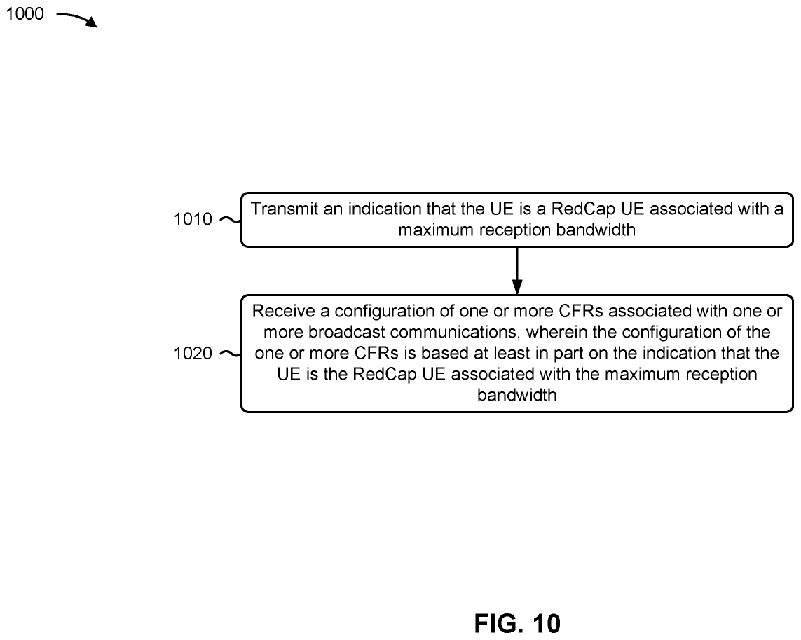

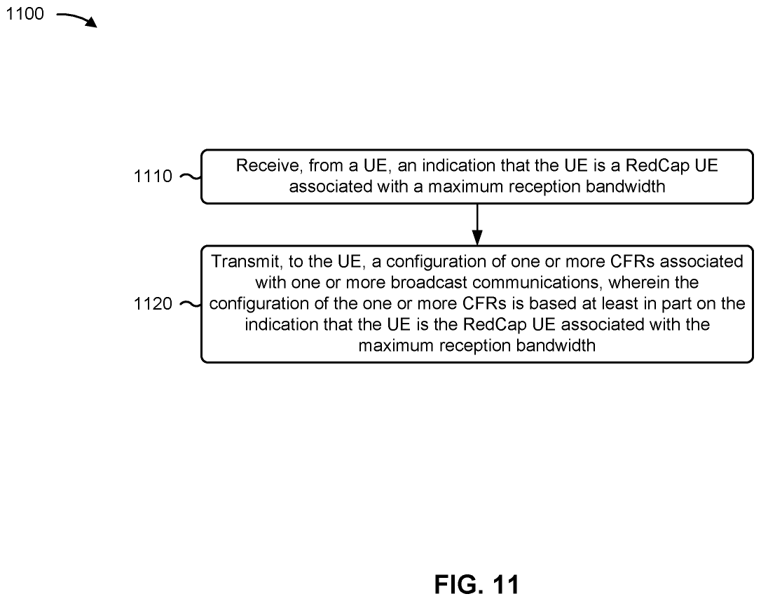

The controller/processor 240 of the base station 110, the controller/processor 280 of the UE 120, and/or any other component(s) of FIG. 2 may perform one or more techniques associated with broadcast configurations for RedCap UEs, as described in more detail elsewhere herein. In some aspects, the network entity described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for transmitting, to a network entity, an indication that the UE 120 is a RedCap UE associated with a maximum reception bandwidth; and/or means for receiving, from the network entity, a configuration of one or more CFRs associated with one or more broadcast communications, wherein the configuration of the one or more CFRs is based at least in part on the indication that the UE is the RedCap UE associated with the maximum reception bandwidth. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for receiving, from a UE (e.g., UE 120), an indication that the UE is a RedCap UE associated with a maximum reception bandwidth; and/or means for transmitting, to the UE, a configuration of one or more CFRs associated with one or more broadcast communications, wherein the configuration of the one or more CFRs is based at least in part on the indication that the UE is the RedCap UE associated with the maximum reception bandwidth. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of an O-RAN architecture, in accordance with the present disclosure. As shown in FIG. 3, the O-RAN architecture may include a centralized unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

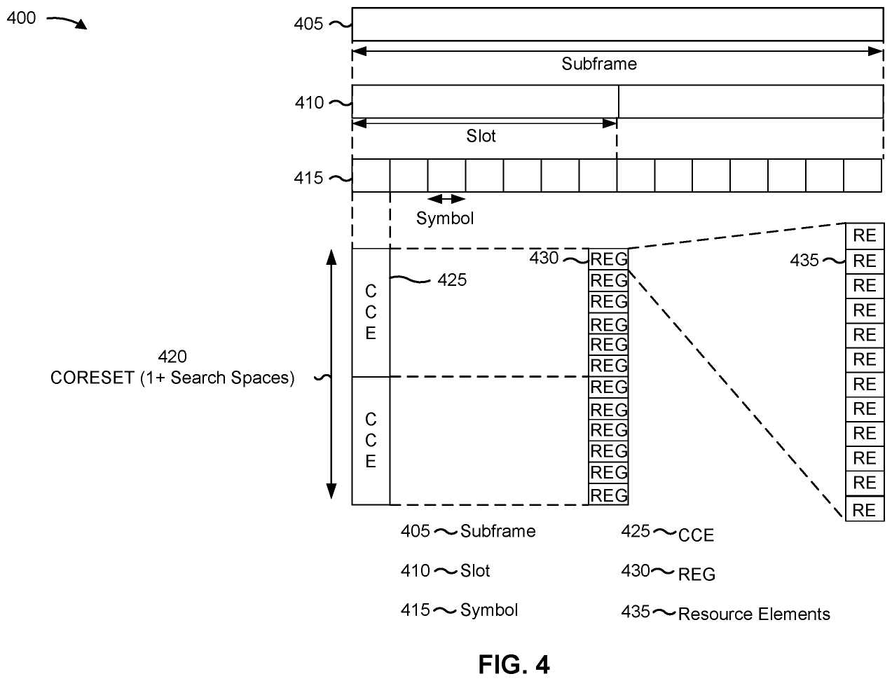

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a control resource set (CORESET) 420 and may be structured to support an efficient use of resources, such as by flexible configuration or reconfiguration of resources of the CORESET 420 for one or more physical downlink control channels (PDCCHs) and/or one or more physical downlink shared channels (PDSCHs). In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured, such as by using RRC signaling to indicate a frequency domain region (e.g., a quantity of resource blocks) and/or a time domain region (e.g., a quantity of symbols) for the CORESET 420.

As illustrated, a symbol 415 that includes CORESET 420 may include one or more control channel elements (CCEs) 425, shown as two CCEs 425 as an example, that span a portion of the system bandwidth. A CCE 425 may include downlink control information (DCI) that is used to provide control information for wireless communication. A base station may transmit DCI during multiple CCEs 425 (as shown), where the quantity of CCEs 425 used for transmission of DCI represents the aggregation level (AL) used by the BS for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

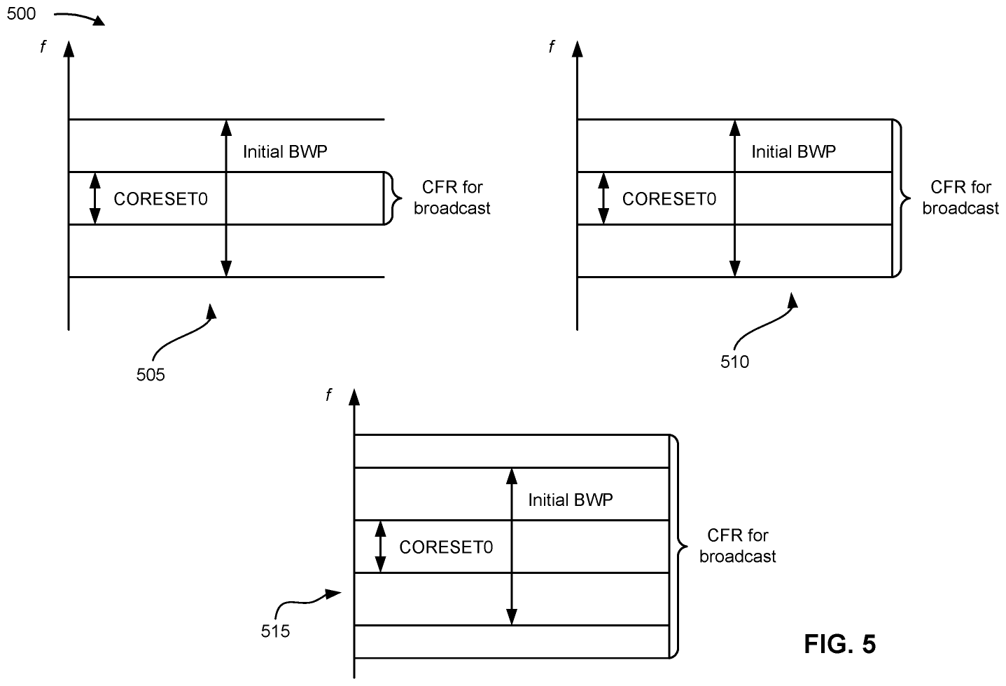

In some aspects, a CORESET (e.g., CORESET 420) may be associated with, contained within, and/or coextensive with an initial bandwidth part (BWP), which may be a contiguous set of physical resource blocks (PRBs) used by a UE to perform an initial access process or the like, and/or a CFR, which may be used for purposes of transmitting certain broadcast communications and/or channels. Aspects of the CFR are described in more detail in connection with FIG. 5.

As indicated above, FIG. 4 is provided as an example. Other examples may differ from what is described with respect to FIG. 4.

FIG. 5 is a diagram illustrating an example 500 of CFR structures for broadcast communications, in accordance with the present disclosure.

In some cases, a UE 120 may be configured with a CFR for receiving various broadcast communications from a network entity, such as a base station 110, a CU 310, a DU 330, an RU 340, or a similar network entity. A CFR may be a contiguous set of PRBs used by the UE 120 to receive broadcast communications, such as communications associated with a multimedia broadcast multicast service (MBMS) point-to-multipoint control channel (MCCH) and/or communications associated with an MBMS point-to-multipoint traffic channel (MTCH). In some cases, the UE 120 may receive broadcast control communications via the MCCH and may receive broadcast data communications via the MTCH. Moreover, the UE 120 may be configured with a CFR location and bandwidth parameter (sometimes referred to as locationAndBandwidth-Broadcast) identifying the CFR.

In some cases, and as shown by reference number 505, the CFR may be configured to have the same bandwidth as a CORESET (indexed as CORESET0 in the examples shown in FIG. 5, which may correspond to the CORESET 420 described in connection with FIG. 4 or a similar CORESET). CORESET0 is configured by the master information block (MIB) and used for system information block (SIB) type 1 (SIB1) scheduling, which includes the initial access configuration for RRC_IDLE/INACTIVE UEs. Additionally, or alternatively, and again as shown by reference number 505, the CFR may be configured to have the same bandwidth size as CORESET0 but a smaller bandwidth than an initial BWP. As described in connection with FIG. 4, the initial BWP which may be a contiguous set of PRBs used by a UE (e.g., UE 120) as the first active BWP after RRC connection or the like, which, in some cases, may be configured by a SIB message received from a network entity, such as SIB1. In some cases, the configuration shown by reference number 505 may be referred to as “Case A.” In some other cases, and as shown by reference number 510, the CFR may be configured to have a larger bandwidth than a bandwidth of the CORESET (e.g., CORESET0). More particularly, in the example shown by reference number 510, the CFR has the same bandwidth as the initial BWP, and the bandwidth of both the CFR and the initial BWP are larger than a bandwidth of the CORESET (e.g., CORESET0). In some cases, the configuration shown by reference number 510 may be referred to as “Case C.” In some other cases, and as shown by reference number 515, the CFR may be configured to have a larger bandwidth than both a bandwidth of the CORESET (e.g., CORESET0) and a bandwidth of the initial BWP. More particularly, in the example shown by reference number 515, the CFR has a larger bandwidth than the initial BWP, and the initial BWP has a larger bandwidth than a bandwidth of the CORESET. In some cases, the configuration shown by reference number 515 may be referred to as “Case E.” In each case (e.g., Case A, Case C, and Case E), the CFR may fully contain the CORESET (e.g., CORESET0) and may have the use the same cyclic prefix and/or subcarrier spacing as the CORESET and the initial BWP.

According to certain legacy procedures, a UE 120 can only be configured with one of the above CFR configurations. Put another way, a UE 120 may only be configured with one locationAndBandwidth-Broadcast parameter identifying the CFR. Moreover, in some cases the UE 120 may be configured with resources associated with an MCCH and/or an MTCH within the CFR. More particularly, the UE 120 may be configured with resources/parameters associated with an MCCH by a broadcast SIB message (sometimes referred to as a SIBx message). For example, a SIBx message may configure a set of parameters for PDCCH and/or a set of parameters for PDSCH associated with an MCCH (sometimes referred to as PDCCH-Config-MCCH and PDSCH-Config-MCCH, respectively). And a broadcast control message received via the MCCH may configure a set of parameters for PDCCH and/or a set of parameters for PDSCH associated with an MTCH (sometimes referred to as PDCCH-Config-MTCH and PDSCH-Config-MTCH, respectively). In some cases, the UE 120 may not separately be configured with a set of parameters for PDCCH and/or a set of parameters for PDSCH associated with an MTCH (e.g., the UE 120 may not receive a PDCCH-Config-MTCH or a PDSCH-Config-MTCH), and thus the configuration of the resources associated with the MCCH (e.g., PDCCH-Config-MCCH and PDSCH-Config-MCCH) may also be used for the MTCH.

In some aspects, a UE 120 monitoring the CFR for broadcast communications (e.g., one or more broadcast control communications associated with the MCCH and/or one or more broadcast data communications associated with the MTCH) may be a RedCap UE. A RedCap UE may be a UE that is designed to achieve lower cost, reduced complexity, longer battery life, and/or a smaller form factor than a non-RedCap UE (e.g., a UE exhibiting normal capabilities and functionality). For example, in some cases, a RedCap UE may exhibit lower complexity than a non-RedCap UE because a RedCap UE is associated with a maximum bandwidth smaller than that of a non-RedCap UE. In some cases, a maximum bandwidth of a RedCap UE operating in FR1 during and after initial access may be 20 MHz, and/or a maximum bandwidth of a RedCap UE operating in FR2 during and after initial access may be 100 MHz. Moreover, in some cases a RedCap UE may not support carrier aggregation and/or dual connectivity operation.

Additionally, or alternatively, in some cases, a RedCap UE may exhibit lower complexity than a non-RedCap UE because a RedCap UE is associated with a reduced minimum number of reception branches as compared to a non-RedCap UE. For example, with respect to frequency bands where a non-RedCap UE is required to be equipped with a minimum of two or four reception antenna ports, a RedCap UE may only be required to be equipped with a minimum of one or two reception antenna ports, respectively. Additionally, or alternatively, in some cases, a RedCap UE may exhibit lower complexity than a non-RedCap UE because a RedCap UE may be associated with a lower maximum number of downlink MIMO layers as compared to a non-RedCap UE. For example, in cases in which a RedCap UE is associated with one reception branch, one downlink MIMO layer may be supported. while in cases in which a RedCap UE is associated with two reception branches, two downlink MIMO layers may be supported. Additionally, or alternatively, a RedCap UE may exhibit lower complexity than a non-RedCap UE because a RedCap UE may be associated with a relaxed maximum modulation order. For example, while a non-RedCap UE may be required to support 256 quadrature amplitude modulation (QAM), support of 256 QAM may be optional for a RedCap UE (e.g., a RedCap UE may only be required to support 64 QAM).

Notably, a network entity may not consider the capability limitations of RedCap UEs, which may only require low data rate broadcast services, when configuring a CFR (e.g., when configuring the locationAndBandwidth-Broadcast parameter), such as one of the CFRs shown in connection with reference numbers 505, 510, and 515. Accordingly, a network entity may configure a CFR that cannot be monitored by a band-limited RedCap UE. For example, in cases in which the CORESET0 shown in FIG. 5 has the same bandwidth as a maximum reception bandwidth of a RedCap UE (e.g., 20 MHz in FR1, or the like), a RedCap UE may be capable of fully monitoring the CFR when the CFR is configured as shown by reference number 505 (e.g., the RedCap UE may be capable of fully monitoring the CFR when configured according to Case A). However, the RedCap UE may not be capable of fully monitoring the CFR when the CFR is configured as shown by reference number 510 or 515 (e.g., the RedCap UE may not be capable of fully monitoring the CFR when configured according to Case C or Case E). In such instances, a RedCap UE may not receive certain broadcast communications (e.g., broadcast communications transmitted in the CFR outside of the CORESET0 and/or outside of the RedCap UE's maximum reception bandwidth), thus resulting in unreliable communications, increased resource consumption for retransmissions and similar communications via point to point transmission to each RedCap UE, and increased latency and reduced throughput associated with RedCap UE communications.

Some techniques and apparatuses described herein enable flexible CFR configurations for different types of broadcast UEs (e.g., RedCap UEs and non-RedCap UEs) and/or for different types of broadcast services. For example, in some aspects, a UE (e.g., UE 120) may transmit. to a network entity (e.g., a base station 110, a CU 310, a DU 330, an RU 340, or a similar network entity), an indication that the UE is a RedCap UE associated with a maximum reception bandwidth. In response, the UE may receive, from the network entity, a configuration of one or more CFRs associated with one or more broadcast communications. In some aspects, the configuration of the one or more CFRs may include a single, bandlimited CFR that both RedCap UEs and non-RedCap UEs are capable of monitoring. In some other aspects, the configuration of the one or more CFRs may include multiple CFRs, such as a first, band-limited CFR that both RedCap UEs and non-RedCap UEs are capable of monitoring, and a second, non-band-limited CFR that only non-RedCap UEs are capable of monitoring. In such aspects, certain low-data-rate services and similar broadcast communications, which may be targeted to RedCap UEs or may be applicable to the RedCap UE functionality, may be transmitted using the first CFR, while other high-data-rate services and similar broadcast communications, which may not be targeted to RedCap UEs or may not be applicable to the RedCap UE functionality, may be transmitted using the second CFR. As a result, a RedCap UE may receive applicable broadcast communications and services that are transmitted in the first, bandlimited CFR and/or within the RedCap UE's maximum reception bandwidth, thus resulting in most reliable broadcast communications with RedCap UEs and thus decreased resource consumption, decreased latency, increased throughput, and overall more efficient network resource utilization.

As indicated above, FIG. 5 is provided as an example. Other examples may differ from what is described with respect to FIG. 5.

FIG. 6 is a diagram of an example 600 associated with broadcast configurations for RedCap UEs, in accordance with the present disclosure. As shown in FIG. 6, a UE 605 (e.g., UE 120) and a network entity (e.g., base station 110, a CU 310, a DU 330, and/or an RU 340) may communicate with one another. In some aspects, the UE 605 and the network entity 610 may be part of a wireless network (e.g., wireless network 100). The UE 605 and the network entity 610 may have established a wireless connection prior to operations shown in FIG. 6. In some aspects, the UE 605 may be a RedCap UE associated with a maximum reception bandwidth, such as one of the RedCap UEs described in connection with FIG. 5.

As shown by reference number 615, the UE 605 may transmit, to the network entity 610, information indicating that the UE 605 is a RedCap UE and/or indicating capability information associated with the UE 605 being a RedCap UE. For example, the UE 605 may transmit capability information as part of an initial access procedure or as part of a UE registration procedure. In some aspects, the information may indicate that the UE 605 is a RedCap UE associated with a maximum reception bandwidth. For example, and as described in connection with FIG. 5, when the UE 605 and the network entity 610 are communicating in FR1, the maximum reception bandwidth may be 20 MHz. When the UE 605 and the network entity 610 are communicating in FR2, the maximum reception bandwidth may be 100 MHz. In some aspects, instead of, or in addition to, the UE 605 indicating that the UE 605 is a RedCap UE, the UE 605 may transmit broadcast reception capability information. For example, the UE 605 may transmit an indication that UE 605 is receiving broadcast transmissions. Moreover, the UE 605 may report the maximum reception bandwidth, may report a maximum data rate of received broadcast services, or may report similar broadcast reception parameters during registration of the UE 605 to the wireless network, may report whether the UE 605 supports carrier aggregation and/or dual connectivity (e.g., the UE 605 may transmit an indication that the UE 605 does not support carrier aggregation and/or dual connectivity), may report a maximum number of reception branches associated with the UE 605 (e.g., the UE 605 may transmit an indication that the UE 605 is equipped with two or four reception ports), may report a maximum number of downlink MIMO layers associated with the UE 605 (e.g., the UE 605 may transmit an indication an indication that the UE 605 supports one or two downlink MIMO layers), may report a maximum modulation order associated with the UE 605 (e.g., the UE 605 may transmit an indication that the UE 605 supports up to 64 QAM), or similar capability information.

As shown by reference number 620, the UE 605 may receive, from the network entity 610, configuration information. In some aspects, the UE 605 may receive the configuration information via one or more of broadcast SIB/RRC, or unicast RRC signaling, one or more MAC control elements (MAC-CEs), and/or DCI, among other examples. In some aspects, the configuration information may include an indication of one or more configuration parameters (e.g., already known to the UE 605 and/or previously indicated by the network entity 610 or other network device) for selection by the UE 605, and/or explicit configuration information for the UE 605 to use to configure the UE 605, among other examples.

In some aspects, the configuration information may include a configuration of one or more CFRs associated with one or more broadcast communications. The configuration of the one or more CFRs may be based at least in part on the indication that the UE 605 is the RedCap UE associated with the maximum reception bandwidth. In this way, the one or more CFRs may be configured in a way such that the UE 605 is capable of monitoring at least one CFR for broadcast communications and/or broadcast services applicable to RedCap UEs. More particularly, the one or more CFRs may include at least one CFR associated with a bandwidth less than or equal to the maximum reception bandwidth of the UE 605. In some aspects, the one or more CFRs may also include one or more additional CFRs associated with a larger bandwidth for transmitting broadcast communications to non-RedCap UEs, thereby enabling higher broadcast data rates for broadcast services that may not be applicable to the RedCap UE.

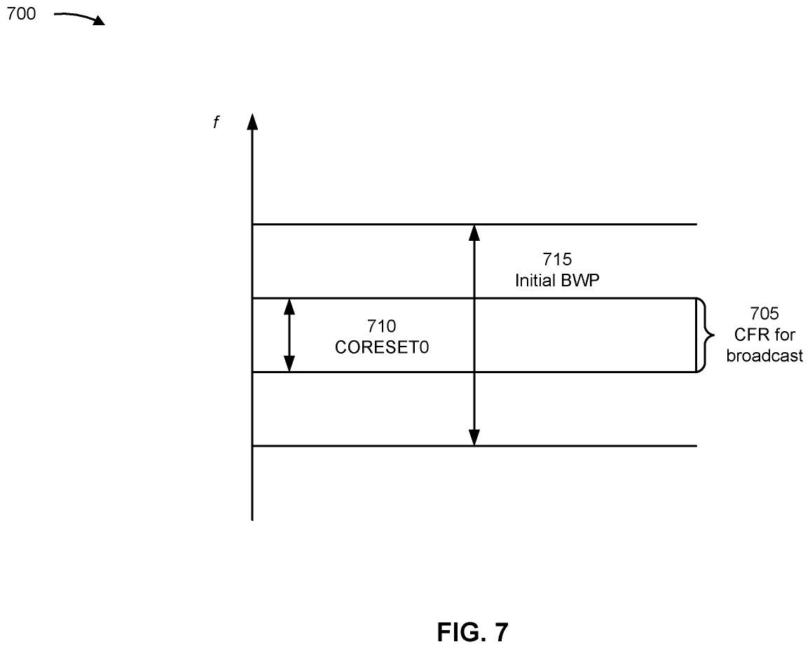

More particularly, in some aspects, the configuration of the one or more CFRs may configure a single CFR, and a bandwidth associated with the single CFR may be based at least in part on a bandwidth associated with a CORESET, such as the CORESET 420 described in connection with FIG. 4 and/or the CORESET0 described in connection with FIG. 5. In such aspects, the bandwidth associated with the CORESET and the bandwidth associated with the single CFR may be less than or equal to the maximum reception bandwidth of the UE 605. In this way, the UE 605 and other RedCap UEs may be capable of monitoring the single CFR for broadcast communications, because the bandwidth is no greater than the maximum reception bandwidth of the UE 605 and/or other RedCap UEs. Aspects of a single configured CFR are described in more detail in connection with FIG. 7.

In some other aspects, the configuration of the one or more CFRs may configure multiple CFRs, such as a first CFR and a second CFR. In such aspects, a bandwidth associated with the second CFR may be larger than a bandwidth associated with the first CFR, and, based at least in part on the UE 605 being the RedCap UE associated with the maximum reception bandwidth, the bandwidth associated with the first CFR may be less than or equal to the maximum reception bandwidth. In this way, the UE 605 may be configured to monitor the first CFR (e.g., the CFR associated with the smaller bandwidth) and not the second CFR, while one or more non-RedCap UEs may be configured to monitor the first CFR and/or the second CFR. In some aspects, the network entity 610 may thus transmit broadcast communications and/or broadcast services applicable to RedCap UEs and to other UEs via the first CFR, and may transmit broadcast communications and/or broadcast services that may not be applicable to RedCap UEs and/or that may require higher data rates or the like via the second CFR.

More particularly, in some aspects, the first CFR may be associated with (e.g., may be used to transmit) a first broadcast communication that is associated with a first MCCH (sometimes referred to herein as MCCH1) or a first MTCH (sometimes referred to herein as MTCH1), and the second CFR may be associated with (e.g., may be used to transmit) a second broadcast communication associated with at least one of a second MCCH (sometimes referred to herein as MCCH2) or a second MTCH (sometimes referred to herein as MTCH2). In that regard, MCCH1 and/or MTCH1 may be used for broadcast communications or services associated with RedCap UEs, and thus the UE 605 and other RedCap UEs may monitor the first CFR for MCCH1 and MTCH1, while MCCH2 and/or MTCH2 may be used for broadcast communications or services associated with non-RedCap UEs, and thus the non-RedCap UEs may monitor the second CFR for MCCH2 and MTCH2.

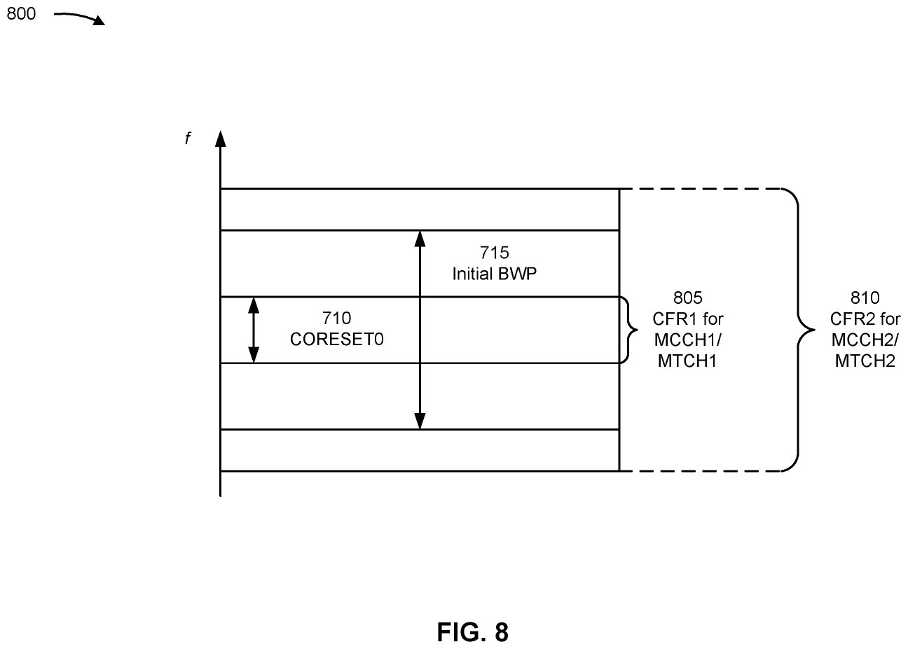

In some aspects, for any broadcast services applicable to both RedCap UEs and non-RedCap UEs, the network entity 610 may transmit a broadcast communication and/or a broadcast service using both the first CFR and the second CFR. This may ensure that all UEs receive the broadcast communication, even if non-RedCap UEs are only monitoring the second CFR, and not both the first CFR and the second CFR. Moreover, such a broadcast communication may be associated with one or more group radio network temporary identifiers (G-RNTI), which may identify the type of broadcast service and/or the broadcast communication, or the like. Moreover, in some aspects the first CFR may be confined within the second CFR. This may reduce monitoring complexity for non-RedCap UEs to monitor both the first CFR and the second CFR, because the non-RedCap UEs may need to only monitor the wider bandwidth associated with the second CFR to receive broadcast services and/or broadcast communications transmitted in the first CFR or the second CFR without RF retuning. Aspects of separate CFRs for RedCap UEs and non-RedCap UEs are described in more detail in connection with FIG. 8.

In some other aspects, different CFRs may be used for different MTCH services or the like. More particularly, in aspects where two CFRs are configured by the configuration information indicated by reference number 620, the first CFR (e.g., the CFR including a bandwidth associated with the maximum reception bandwidth of the UE 605) may be associated with a first set of broadcast services associated with a MTCH, and the second CFR (e.g., the CFR with a wider bandwidth than the maximum reception bandwidth of the UE 605) may be associated with a second set of broadcast services associated with the MTCH. Moreover, the first CFR may be associated with an MCCH, which, in some aspects, may be used to transmit a configuration of the second CFR. Thus, in some aspects, the first CFR (e.g., the CFR with the smaller bandwidth) may be configured for MCCH and some MTCH services to be received by RedCap UEs, while the second CFR (e.g., the CFR with the wider bandwidth) may be configured for other MTCH services to be received by non-RedCap UEs.

The UE 605 may configure itself based at least in part on the configuration information described in connection with reference number 620. In some aspects, the UE 605 may be configured to perform one or more operations described herein based at least in part on the configuration information described in connection with reference number 620.

As shown by reference number 625, in some aspects the UE 605 may receive, from the network entity, an indication of resources associated with a PDSCH associated with a first broadcast service. For example, in aspects in which the configuration of the one or more CFRs configures both the first CFR and the second CFR, the UE 605 may monitor the first CFR and thus may receive the indication of resources associated with the PDSCH associated with a first broadcast service via the first CFR. In some aspects, the PDSCH may be associated with an MTCH. Moreover, in some aspects, the network entity 610 may transmit the indication using both the first CFR and the second CFR. More particularly, the network entity 610 may transmit a first PDCCH associated with the first CFR and a second PDCCH associated with the second CFR. In some aspects, when the UE 605 receives the indication of the resources associated with the PDSCH via the first PDCCH (e.g., the PDCCH associated with the first CFR), the UE 605 may assume that a frequency domain resource allocation (FDRA) associated with the PDSCH is scaled to a bandwidth associated with the first CFR. However, for non-RedCap UEs that receive the indication of the resources associated with the PDSCH via the second PDCCH (e.g., the PDCCH associated with the second CFR), the non-RedCap UEs may assume that the FDRA associated with the PDSCH is scaled to a bandwidth associated with the second CFR. A non-RedCap UE (e.g., UE 605) may monitor the first PDCCH in the first search space set configured in the first CFR and the second PDCCH in the second search space set configured in the second CFR, scheduling the same PDSCH. A network entity (e.g., network entity 610) may configure the link between the first search space and second search space set so that the UE can combine the first PDCCH and second PDCCH to improve decoding performance. Aspects of utilizing different CFRs for different MTCH services are described in more detail in connection with FIG. 10.

Based at least in part on network entity 610 configuring at least one CFR associated with a bandwidth limited by a maximum reception bandwidth of one or more RedCap UEs in response to receiving an indication that one or more RedCap UEs are monitoring broadcast services and/or communications, the UE 605 and/or the network entity 610 may conserve computing, power, network, and/or communication resources that may have otherwise been consumed by configuring a single CFR associated with a wider bandwidth than a maximum reception bandwidth of the UE 605. For example, based at least in part on network entity 610 configuring at least one CFR associated with a reduced bandwidth in response to receiving an indication that one or more RedCap UEs are monitoring broadcast services and/or communications, the UE 605 and the network entity 610 may communicate with a reduced error rate, which may conserve computing, power, network, and/or communication resources that may have otherwise been consumed to detect and/or correct communication errors.

As indicated above, FIG. 6 is provided as an example. Other examples may differ from what is described with respect to FIG. 6.

FIG. 7 is a diagram of an example 700 associated with broadcast configurations for RedCap UEs, in accordance with the present disclosure.

In the aspect shown in FIG. 7, based at least in part on receiving an indication that at least one RedCap UE (e.g., the UE 605) is monitoring broadcast communications, the network entity 610 may configure the same CFR for all broadcast UEs and/or for all broadcast services. More particularly, the network entity 610 may configure a single CFR 705 with a bandwidth size limited by a maximum reception bandwidth of the RedCap UEs. In some aspects, the network entity 610 may configure the single CFR 705 with a bandwidth size limited by the bandwidth associated with a CORESET, such as CORESET0 710 in the example shown in FIG. 7. For example, in aspects in which the network entity 610 and one or more RedCap UEs are operating in FR1, CORESET0 710 may have a bandwidth of 20 MHz, and thus the single CFR 705 configured by the network entity may similarly have a bandwidth of 20 MHz. Additionally, or alternatively, in some aspects, the single CFR 705 may have a bandwidth that is less than a bandwidth associated with an initial BWP 715. In such aspects, because only a single, band-limited CFR 705 is configured, high-data-rate broadcast services, which may not be able to be scheduled in the limited bandwidth, may be not transmitted by the network entity 610. Put another way, in some aspects the network entity 610 may sacrifice the transmission of certain broadcast services in order to ensure all UEs (e.g., RedCap UEs and non-RedCap UEs) are capable of receiving all broadcast communications. In some aspects, when a single CFR 705 is configured as shown in FIG. 7, an MCCH and an MTCH may be associated with the same resources (e.g., the UE 120 may not separately be configured with a set of parameters for PDCCH and/or a set of parameters for PDSCH associated with an MTCH (e.g., the UE 120 may not receive a PDCCH-Config-MTCH or a PDSCH-Config-MTCH), and thus the configuration of the resources associated with the MCCH (e.g., PDCCH-Config-MCCH and PDSCH-Config-MCCH) may be applied to the MTCH).

As indicated above, FIG. 7 is provided as an example. Other examples may differ from what is described with respect to FIG. 7.

FIG. 8 is a diagram of an example 800 associated with broadcast configurations for RedCap UEs, in accordance with the present disclosure.

In the aspect shown in FIG. 8, based at least in part on receiving an indication that at least one RedCap UE (e.g., the UE 605) is monitoring broadcast communications, the network entity 610 may configure separate CFRs for RedCap UEs and for non-RedCap UEs. More particularly, the network entity 610 may configure a first CFR (indicated as CFR1 805 in FIG. 8) and a second CFR (indicated as CFR2 810 in FIG. 8), with CFR1 805 having a smaller bandwidth for use by RedCap UEs to monitor broadcast communications, and with CFR2 810 having a larger bandwidth for use by non-RedCap UEs to monitor broadcast communications. For example, a bandwidth associated with CFR1 805 may correspond to a bandwidth associated with CORSET0 710, while a bandwidth associated with CFR2 810 may be larger than a bandwidth associated with CORESET0 710. In some aspects, the bandwidth associated with CFR2 810 may be less than, equal to, or greater than a bandwidth associated with the initial BWP 715. For example, in the aspect shown in FIG. 8, the bandwidth associated with CFR2 810 is greater than the initial BWP 715.

In that regard, RedCap UEs may receive one or both of a first MCCH (indicated as MCCH1 in FIG. 8) or a first MTCH (indicated as MTCH1 in FIG. 8) in CFR1 805, and non-RedCap UEs may receive one or both of a second MCCH (indicated as MCCH2 in FIG. 8) or a second MTCH (indicated as MTCH2 in FIG. 8) in CFR2 810. Put another way, RedCap UEs may only need to monitor CFR1 805, which corresponds to a maximum reception bandwidth of the RedCap UEs, while non-RedCap UEs (and thus non band-limited UEs) may only need to monitor CFR2 810, which has a larger bandwidth than a maximum reception bandwidth of the RedCap UEs and thus may be used to transmit certain high-data-rate broadcast communications or services, or the like. In some aspects, the network entity 610 may transmit a certain broadcast service (e.g., a broadcast service applicable to both RedCap UEs and non-RedCap UEs) separately in CFR1 805 and CFR2 810. Moreover, in some aspects one or more G-RNTIs corresponding to a broadcast service may be configured in MTCH1 or MTCH2. Thus, to receive a particular broadcast service, a RedCap UE may monitor MTCH1 for the one or more G-RNTIs corresponding to the corresponding broadcast service, while a non-RedCap UE may monitor MTCH2 for the one or more G-RNTIs corresponding to the corresponding broadcast service.

As indicated above, FIG. 8 is provided as an example. Other examples may differ from what is described with respect to FIG. 8.

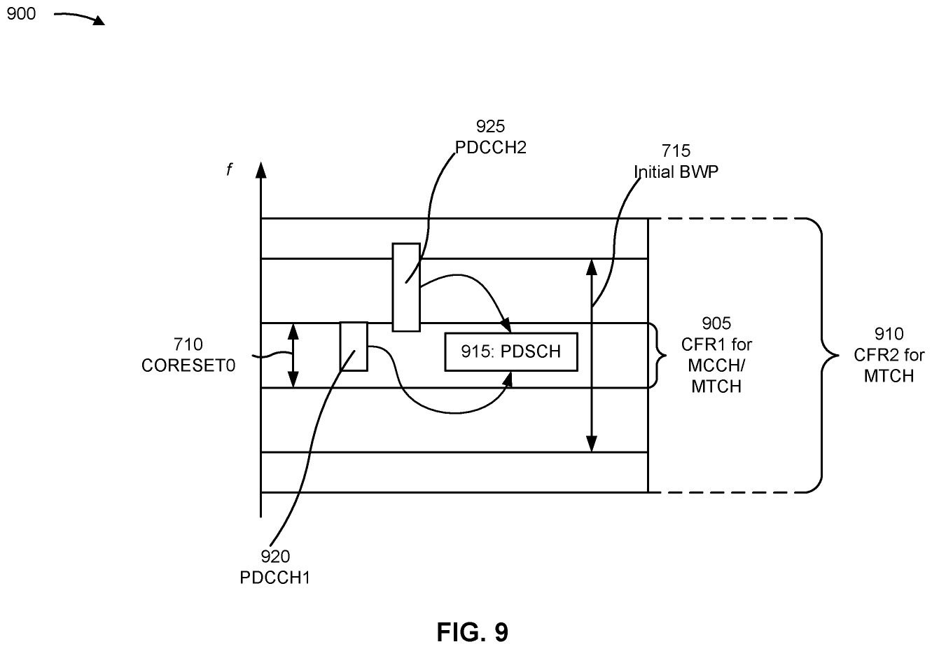

FIG. 9 is a diagram of an example 900 associated with broadcast configurations for RedCap UEs, in accordance with the present disclosure.

In the aspect shown in FIG. 9, based at least in part on receiving an indication that at least one RedCap UE (e.g., the UE 605) is monitoring broadcast communications, the network entity 610 may configure separate CFRs for RedCap UEs and for non-RedCap UEs, in a similar manner as described above in connection with FIG. 8. More particularly, the network entity 610 may configure CFR1 905 and CFR2 910, with CFR1 905 having a smaller bandwidth for use by RedCap UEs to monitor broadcast communications, and with CFR2 910 having a larger bandwidth for use by non-RedCap UEs to monitor broadcast communications, as described.

In this aspect, however, the separate CFRs (e.g., CFR1 905 and CFR2 910) may be used for broadcasting different MTCH services. Put another way, broadcast services applicable to RedCap UEs or to both RedCap UEs and non-RedCap UEs may be transmitted in CFR1 905 to ensure that the RedCap UEs are capable of receiving the transmissions. However, certain high-data-rate broadcast services or similar services, which may not be applicable to RedCap UEs and/or which may need a larger bandwidth for transmission than a bandwidth associated with CFR1 905, may be transmitted in CFR2 910 for reception by non-RedCap UEs. Moreover, in some aspects, the network entity 610 may configure CFR1 905 to include the MCCH. Thus, RedCap UEs and non-RedCap UEs may monitor CFR1 905 for MCCH communications and certain MTCH communications, and non-RedCap UEs may additionally monitor CFR2 910 for other MTCH communications (e.g., high-data-rate broadcast services or the like). Additionally, in some aspects, CFR2 may be configured by a MCCH communication transmitted in CFR1 905. In such aspects, RedCap UEs may disregard the configuration of CFR2 910 because the associated bandwidth exceeds the maximum reception bandwidth of RedCap UEs, while non-RedCap UEs may, in response to receiving the configuration of CFR2 910, begin to monitor CFR2 910 (in addition to CFR1 905) in order to receive certain broadcast services. Put another way, in some aspects, non-RedCap UEs may monitor CFR1 905 for MCCH communications, and may monitor both CFR1 905 and CFR2 910 for different types of MTCH services. In some aspects, CFR1 905 may be confined within CFR2 910 (as shown in FIG. 9), while, in some other aspects, CFR1 905 may not be confined within CFR2 910. Beneficially, confining CFR1 905 within CFR2 910 may simply the complexity for broadcast monitoring by non-RedCap UEs, as the non-RedCap UEs may simply monitor the frequency band associated with CFR2 910 and do not need to monitor non-contiguous bands, or the like.

In some aspects, the network entity 610 may transmit a certain broadcast service (which may be indicated using one or more G-RNTIs, as described) in an overlapped range of CFR1 905 and CFR2 910. For example, as shown in FIG. 9, a PDSCH 915, which may carry an MTCH including the one or more G-RNTIs (e.g., the PDSCH 915 may be used to transmit a certain broadcast service), may be located within an overlapped range of CFR1 905 and CFR2 910. In such aspects, the network entity 610 may schedule the PDSCH 915 using a first DCI in a PDCCH in CFR1 905 (indicated as PDCCH1 920 in FIG. 9) and a second DCI in a PDCCH in CFR2 910 (indicated as PDCCH2 925 in FIG. 9). Thus, RedCap UEs may monitor PDCCH1 920 for receiving the first DCI, while non-RedCap UEs may monitor PDCCH1 920 and/or PDCCH2 925 for receiving the first DCI and/or the second DCI. In such aspects, a UE monitoring PDCCH1 920 in CFR1 905 (e.g., a RedCap UE and/or a non-RedCap UE monitoring CFR1 905) may assume that an FDRA indicated by the first DCI is scaled to the bandwidth of CFR1 905. Similarly, a UE monitoring PDCCH2 925 in CFR2 910 (e.g., a non-RedCap UE) may assume that an FDRA indicated by the second DCI is scaled to the bandwidth of CFR2 910. In some aspects, one or both of the first DCI and the second DCI may be a DCI format 4_0 communication. For example, non-RedCap UEs may receive a DCI format 4_0 communication in PDCCH2 925 that schedules the PDSCH 915, and the non-RedCap UEs may assume that an FDRA of the PDSCH 915 is scaled to the bandwidth of CFR2 910. Alternatively, in some aspects a UE monitoring PDCCH1 920 within the range of CFR1 905 will assume an FDRA of the PDSCH 915 is scaled to the bandwidth of CFR1 905, and will otherwise assume that an FDRA of the PDSCH 915 is scaled to the bandwidth of CFR2 925.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 605) performs operations associated with broadcast configurations for RedCap UEs.

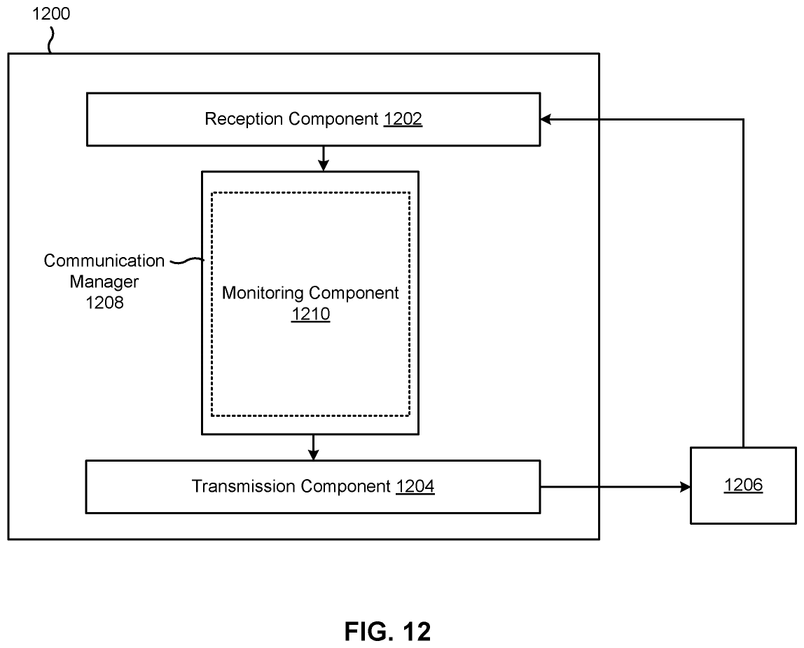

As shown in FIG. 10, in some aspects, process 1000 may include transmitting (e.g., to a network entity, such as network entity 610), an indication that the UE is a RedCap UE associated with a maximum reception bandwidth (block 1010). For example, the UE (e.g., using communication manager 1208 and/or transmission component 1204, depicted in FIG. 12) may transmit (e.g., to a network entity) an indication that the UE is a RedCap UE associated with a maximum reception bandwidth, as described above.

As further shown in FIG. 10, in some aspects, process 1000 may include receiving (e.g., from the network entity) a configuration of one or more CFRs associated with one or more broadcast communications, wherein the configuration of the one or more CFRs is based at least in part on the indication that the UE is the RedCap UE associated with the maximum reception bandwidth (block 1020). For example, the UE (e.g., using communication manager 1208 and/or reception component 1202, depicted in FIG. 12) may receive (e.g., from the network entity) a configuration of one or more CFRs associated with one or more broadcast communications, wherein the configuration of the one or more CFRs is based at least in part on the indication that the UE is the RedCap UE associated with the maximum reception bandwidth, as described above.

Process 1000 may include additional aspects, such as any single aspect or any combination of aspects described below and/or in connection with one or more other processes described elsewhere herein.

In a first aspect, the configuration of the one or more CFRs configures a single CFR, and a bandwidth associated with the single CFR is based at least in part on a bandwidth associated with a CORESET.

In a second aspect, alone or in combination with the first aspect, the bandwidth associated with the CORESET and the bandwidth associated with the single CFR is less than or equal to the maximum reception bandwidth.

In a third aspect, alone or in combination with one or more of the first and second aspects, the configuration of the one or more CFRs configures a first CFR and a second CFR.

In a fourth aspect, alone or in combination with one or more of the first through third aspects, a bandwidth associated with the second CFR is larger than a bandwidth associated with the first CFR, and, based at least in part on the UE being the RedCap UE associated with the maximum reception bandwidth, the bandwidth associated with the first CFR is less than or equal to the maximum reception bandwidth and the UE is configured to monitor the first CFR and not the second CFR.

In a fifth aspect, alone or in combination with one or more of the first through fourth aspects, a bandwidth associated with the second CFR is larger than a bandwidth associated with the first CFR, and one or more non-RedCap UEs are configured to monitor the first CFR and the second CFR.

In a sixth aspect, alone or in combination with one or more of the first through fifth aspects, the first CFR is associated with a first broadcast communication, of the one or more broadcast communications, associated with at least one of a first MCCH or a first MTCH, and the second CFR is associated with a second broadcast communication, of the one or more broadcast communications, associated with at least one of a second MCCH or a second MTCH.

In a seventh aspect, alone or in combination with one or more of the first through sixth aspects, at least a broadcast communication, of the one or more broadcast communications, is transmitted using both the first CFR and the second CFR.

In an eighth aspect, alone or in combination with one or more of the first through seventh aspects, the broadcast communication is associated with one or more group radio network temporary identifiers.

In a ninth aspect, alone or in combination with one or more of the first through eighth aspects, the first CFR is confined within the second CFR.

In a tenth aspect, alone or in combination with one or more of the first through ninth aspects, the first CFR is associated with a first set of broadcast services associated with an MTCH, and the second CFR is associated with a second set of broadcast services associated with the MTCH.

In an eleventh aspect, alone or in combination with one or more of the first through tenth aspects, the first CFR is associated with an MCCH.

In a twelfth aspect, alone or in combination with one or more of the first through eleventh aspects, a configuration of the second CFR is received via the MCCH in the first CFR.

In a thirteenth aspect, alone or in combination with one or more of the first through twelfth aspects, process 1000 includes receiving an indication of resources associated with a PDSCH associated with a first broadcast service, of the first set of broadcast services, wherein the indication is communicated using both a first PDCCH associated with the first CFR and a second PDCCH associated with the second CFR.

In a fourteenth aspect, alone or in combination with one or more of the first through thirteenth aspects, the UE receives the indication of the resources associated with the PDSCH via the first PDCCH, and a frequency domain resource allocation associated with the PDSCH is scaled to a bandwidth associated with the first CFR.

In a fifteenth aspect, alone or in combination with one or more of the first through fourteenth aspects, process 1000 includes transmitting (e.g., to the network entity) broadcast reception capability information including an indication of at least one of the maximum reception bandwidth associated with the UE, or a maximum data rate of broadcast services associated with the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 610) performs operations associated with broadcast configurations for RedCap UEs.

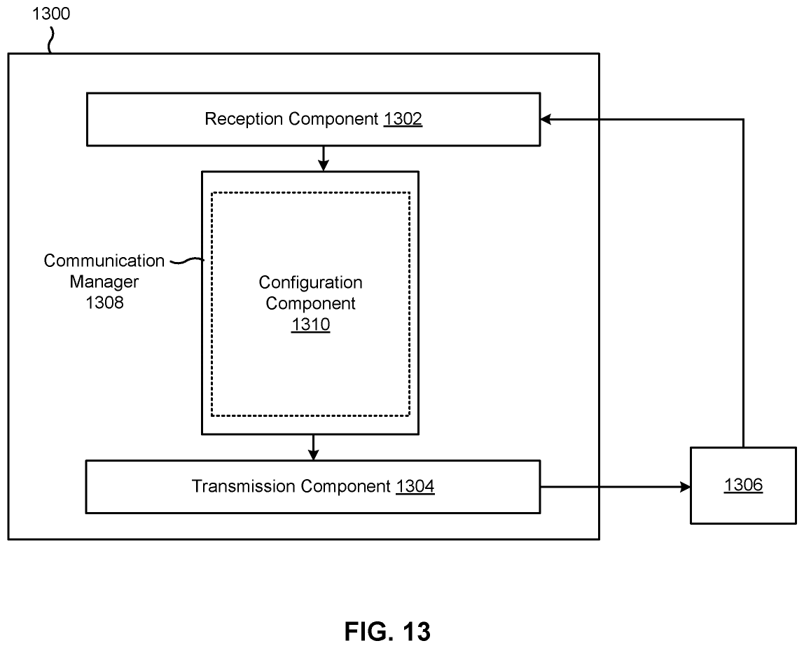

As shown in FIG. 11, in some aspects, process 1100 may include receiving, from a UE (e.g., UE 605), an indication that the UE is a RedCap UE associated with a maximum reception bandwidth (block 1110). For example, the network entity (e.g., using communication manager 1308 and/or reception component 1302, depicted in FIG. 13) may receive, from a UE, an indication that the UE is a RedCap UE associated with a maximum reception bandwidth, as described above.

As further shown in FIG. 11, in some aspects, process 1100 may include transmitting, to the UE, a configuration of one or more CFRs associated with one or more broadcast communications, wherein the configuration of the one or more CFRs is based at least in part on the indication that the UE is the RedCap UE associated with the maximum reception bandwidth (block 1120). For example, the network entity (e.g., using communication manager 1308 and/or transmission component 1304, depicted in FIG. 13) may transmit, to the UE, a configuration of one or more CFRs associated with one or more broadcast communications, wherein the configuration of the one or more CFRs is based at least in part on the indication that the UE is the RedCap UE associated with the maximum reception bandwidth, as described above.

Process 1100 may include additional aspects, such as any single aspect or any combination of aspects described below and/or in connection with one or more other processes described elsewhere herein.

In a first aspect, the configuration of the one or more CFRs configures a single CFR, and a bandwidth associated with the single CFR is based at least in part on a bandwidth associated with a CORESET.

In a second aspect, alone or in combination with the first aspect, the bandwidth associated with the CORESET and the bandwidth associated with the single CFR is less than or equal to the maximum reception bandwidth.

In a third aspect, alone or in combination with one or more of the first and second aspects, the configuration of the one or more CFRs configures a first CFR and a second CFR.

In a fourth aspect, alone or in combination with one or more of the first through third aspects, a bandwidth associated with the second CFR is larger than a bandwidth associated with the first CFR, and, based at least in part on the UE being the RedCap UE associated with the maximum reception bandwidth, the bandwidth associated with the first CFR is less than or equal to the maximum reception bandwidth and the UE is configured to monitor the first CFR and not the second CFR.

In a fifth aspect, alone or in combination with one or more of the first through fourth aspects, process 1100 includes transmitting, to one or more non-RedCap UEs, the configuration of one or more CFRs associated with the one or more broadcast communications, wherein a bandwidth associated with the second CFR is larger than a bandwidth associated with the first CFR, and wherein one or more non-RedCap UEs are configured to monitor the first CFR and the second CFR.

In a sixth aspect, alone or in combination with one or more of the first through fifth aspects, the first CFR is associated with a first broadcast communication associated with at least one of a MCCH or a first MTCH, and the second CFR is associated with a second broadcast communication associated with at least one of a second MCCH or a second MTCH.

In a seventh aspect, alone or in combination with one or more of the first through sixth aspects, at least a broadcast communication, of the one or more broadcast communications, is transmitted using both the first CFR and the second CFR.

In an eighth aspect, alone or in combination with one or more of the first through seventh aspects, the broadcast communication is associated with one or more group radio network temporary identifiers.

In a ninth aspect, alone or in combination with one or more of the first through eighth aspects, the first CFR is confined within the second CFR.

In a tenth aspect, alone or in combination with one or more of the first through ninth aspects, the first CFR is associated with a first set of broadcast services associated with an MTCH, and wherein the second CFR is associated with a second set of broadcast services associated with the MTCH.

In an eleventh aspect, alone or in combination with one or more of the first through tenth aspects, the first CFR is associated with an MCCH.

In a twelfth aspect, alone or in combination with one or more of the first through eleventh aspects, a configuration of the second CFR is transmitted via the MCCH in the first CFR.

In a thirteenth aspect, alone or in combination with one or more of the first through twelfth aspects, process 1100 includes transmitting an indication of resources associated with a PDSCH associated with a first broadcast service, of the first set of broadcast services, wherein the indication is transmitted using both a first PDCCH associated with the first CFR and a second PDCCH associated with the second CFR.

In a fourteenth aspect, alone or in combination with one or more of the first through thirteenth aspects, a frequency domain resource allocation associated with the PDSCH is scaled to a bandwidth associated with the first CFR.

In a fifteenth aspect, alone or in combination with one or more of the first through fourteenth aspects, the indication of the resources associated with the PDSCH transmitted in the second PDCCH is transmitted via a broadcast downlink control information communication, and a frequency domain resource allocation associated with the PDSCH is scaled to a bandwidth associated with the second CFR.

In a sixteenth aspect, alone or in combination with one or more of the first through fifteenth aspects, process 1100 includes receiving, from the UE, broadcast reception capability information including an indication of at least one of the maximum reception bandwidth associated with the UE, or a maximum data rate of broadcast services associated with the UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 605), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 140 may include a monitoring component 1210, among other examples.

In some aspects, the apparatus 1200 may be configured to perform one or more operations described herein in connection with FIGS. 6-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE 120 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE 120 described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE 120 described in connection with FIG. 2. In some aspects, the transmission component 1204 may be co-located with the reception component 1202 in a transceiver.

The transmission component 1204 may transmit (e.g., to a network entity) an indication that the UE is a RedCap UE associated with a maximum reception bandwidth. The reception component 1202 and/or the monitoring component 1210 may receive (e.g., from the network entity) a configuration of one or more CFRs associated with one or more broadcast communications, wherein the configuration of the one or more CFRs is based at least in part on the indication that the UE is the RedCap UE associated with the maximum reception bandwidth.

The reception component 1202 and/or the monitoring component 1210 may receive an indication of resources associated with a PDSCH associated with a first broadcast service, of the first set of broadcast services, wherein the indication is communicated using both a first PDCCH associated with the first CFR and a second PDCCH associated with the second CFR.

The transmission component 1204 may transmit (e.g., to the network entity), broadcast reception capability information including an indication of at least one of the maximum reception bandwidth associated with the UE, or a maximum data rate of broadcast services associated with the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity (e.g., network entity 610), or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may include a configuration component 1310, among other examples.

In some aspects, the apparatus 1300 may be configured to perform one or more operations described herein in connection with FIGS. 6-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the base station 110 described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station 110 described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station 110 described in connection with FIG. 2. In some aspects, the transmission component 1304 may be co-located with the reception component 1302 in a transceiver.

The reception component 1302 may receive, from a UE (e.g., UE 605), an indication that the UE is a RedCap UE associated with a maximum reception bandwidth. The transmission component 1304 and/or the configuration component 1310 may transmit, to the UE, a configuration of one or more CFRs associated with one or more broadcast communications, wherein the configuration of the one or more CFRs is based at least in part on the indication that the UE is the RedCap UE associated with the maximum reception bandwidth.

The transmission component 1304 and/or the configuration component 1310 may transmit, to one or more non-RedCap UEs, the configuration of one or more CFRs associated with the one or more broadcast communications, wherein a bandwidth associated with the second CFR is larger than a bandwidth associated with the first CFR, and wherein one or more non-RedCap UEs are configured to monitor the first CFR and the second CFR.

The transmission component 1304 may transmit an indication of resources associated with a PDSCH associated with a first broadcast service, of the first set of broadcast services, wherein the indication is transmitted using both a first PDCCH associated with the first CFR and a second PDCCH associated with the second CFR.

The reception component 1302 may receive, from the UE, broadcast reception capability information including an indication of at least one of the maximum reception bandwidth associated with the UE, or a maximum data rate of broadcast services associated with the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a UE, comprising: transmitting (e.g., to a network entity) an indication that the UE is a RedCap UE associated with a maximum reception bandwidth; and receiving (e.g., from the network entity) a configuration of one or more CFRs associated with one or more broadcast communications, wherein the configuration of the one or more CFRs is based at least in part on the indication that the UE is the RedCap UE associated with the maximum reception bandwidth.
Aspect 2: The method of Aspect 1, wherein the configuration of the one or more CFRs configures a single CFR, and wherein a bandwidth associated with the single CFR is based at least in part on a bandwidth associated with a CORESET.
Aspect 3: The method of Aspect 2, wherein the bandwidth associated with the CORESET and the bandwidth associated with the single CFR is less than or equal to the maximum reception bandwidth.
Aspect 4: The method of Aspect 1, wherein the configuration of the one or more CFRs configures a first CFR and a second CFR.
Aspect 5: The method of Aspect 4, wherein a bandwidth associated with the second CFR is larger than a bandwidth associated with the first CFR, and wherein, based at least in part on the UE being the RedCap UE associated with the maximum reception bandwidth, the bandwidth associated with the first CFR is less than or equal to the maximum reception bandwidth and the UE is configured to monitor the first CFR and not the second CFR.
Aspect 6: The method of any of Aspects 4-5, wherein a bandwidth associated with the second CFR is larger than a bandwidth associated with the first CFR, and wherein one or more non-RedCap UEs are configured to monitor the first CFR and the second CFR.
Aspect 7: The method of any of Aspects 4-6, wherein the first CFR is associated with a first broadcast communication, of the one or more broadcast communications, associated with at least one of a first MCCH or a first MTCH, and wherein the second CFR is associated with a second broadcast communication, of the one or more broadcast communications, associated with at least one of a second MCCH or a second MTCH.
Aspect 8: The method of any of Aspects 4-7, wherein at least a broadcast communication, of the one or more broadcast communications, is transmitted using both the first CFR and the second CFR.
Aspect 9: The method of Aspect 8, wherein the broadcast communication is associated with one or more group radio network temporary identifiers.
Aspect 10: The method of any of Aspects 4-9, wherein the first CFR is confined within the second CFR.
Aspect 11: The method of any of Aspects 4-10, wherein the first CFR is associated with a first set of broadcast services associated with an MTCH, and wherein the second CFR is associated with a second set of broadcast services associated with the MTCH.
Aspect 12: The method of Aspect 11, wherein the first CFR is associated with an MCCH.
Aspect 13: The method of Aspect 12, wherein a configuration of the second CFR is received via the MCCH in the first CFR.
Aspect 14: The method of any of Aspects 11-13, further comprising receiving an indication of resources associated with a PDSCH associated with a first broadcast service, of the first set of broadcast services, wherein the indication is communicated using both a first PDCCH associated with the first CFR and a second PDCCH associated with the second CFR.
Aspect 15: The method of Aspect 14, wherein the UE receives the indication of the resources associated with the PDSCH via the first PDCCH, and wherein a frequency domain resource allocation associated with the PDSCH is scaled to a bandwidth associated with the first CFR.
Aspect 16: The method of any of Aspects 1-15, further comprising transmitting (e.g., to the network entity) broadcast reception capability information including an indication of at least one of the maximum reception bandwidth associated with the UE, or a maximum data rate of broadcast services associated with the UE.
Aspect 17: A method of wireless communication performed by a network entity, comprising: receiving, from a UE, an indication that the UE is a RedCap UE associated with a maximum reception bandwidth; and transmitting, to the UE, a configuration of one or more CFRs associated with one or more broadcast communications, wherein the configuration of the one or more CFRs is based at least in part on the indication that the UE is the RedCap UE associated with the maximum reception bandwidth.
Aspect 18: The method of Aspect 17, wherein the configuration of the one or more CFRs configures a single CFR, and wherein a bandwidth associated with the single CFR is based at least in part on a bandwidth associated with a CORESET.
Aspect 19: The method of Aspect 18, wherein the bandwidth associated with the CORESET and the bandwidth associated with the single CFR is less than or equal to the maximum reception bandwidth.
Aspect 20: The method of Aspect 17, wherein the configuration of the one or more CFRs configures a first CFR and a second CFR.
Aspect 21: The method of Aspect 20, wherein a bandwidth associated with the second CFR is larger than a bandwidth associated with the first CFR, and wherein, based at least in part on the UE being the RedCap UE associated with the maximum reception bandwidth, the bandwidth associated with the first CFR is less than or equal to the maximum reception bandwidth and the UE is configured to monitor the first CFR and not the second CFR.
Aspect 22: The method of any of Aspects 20-21, further comprising transmitting, to one or more non-RedCap UEs, the configuration of one or more CFRs associated with the one or more broadcast communications, wherein a bandwidth associated with the second CFR is larger than a bandwidth associated with the first CFR, and wherein one or more non-RedCap UEs are configured to monitor the first CFR and the second CFR.
Aspect 23: The method of any of Aspects 20-22, wherein the first CFR is associated with a first MCCH or a first MTCH, and wherein the second CFR is associated with a second broadcast communication associated with at least one of a second MCCH or a second MTCH.
Aspect 24: The method of any of Aspects 20-23, wherein at least a broadcast communication, of the one or more broadcast communications, is transmitted using both the first CFR and the second CFR.
Aspect 25: The method of Aspect 24, wherein the broadcast communication is associated with one or more group radio network temporary identifiers.
Aspect 26: The method of any of Aspects 20-25, wherein the first CFR is confined within the second CFR.
Aspect 27: The method of any of Aspects 20-26, wherein the first CFR is associated with a first set of broadcast services associated with an MTCH, and wherein the second CFR is associated with a second set of broadcast services associated with the MTCH.
Aspect 28: The method of Aspect 27, wherein the first CFR is associated with an MCCH.
Aspect 29: The method of Aspect 28, wherein a configuration of the second CFR is transmitted via the MCCH in the first CFR.
Aspect 30: The method of any of Aspects 27-29, further comprising transmitting an indication of resources associated with a PDSCH associated with a first broadcast service, of the first set of broadcast services, wherein the indication is transmitted using both a first PDCCH associated with the first CFR and a second PDCCH associated with the second CFR.
Aspect 31: The method of Aspect 30, wherein a frequency domain resource allocation associated with the PDSCH is scaled to a bandwidth associated with the first CFR.
Aspect 32: The method of any of Aspects 30-31, wherein the indication of the resources associated with the PDSCH transmitted in the second PDCCH is transmitted via a broadcast downlink control information communication, and wherein a frequency domain resource allocation associated with the PDSCH is scaled to a bandwidth associated with the second CFR.
Aspect 33: The method of any of Aspects 17-32, further comprising receiving, from the UE, broadcast reception capability information including an indication of at least one of the maximum reception bandwidth associated with the UE, or a maximum data rate of broadcast services associated with the UE.
Aspect 34: An apparatus for wireless communication at a device, comprising a processor; memory coupled with the processor; and instructions stored in the memory and executable by the processor to cause the apparatus to perform the method of one or more of Aspects 1-16.
Aspect 35: A device for wireless communication, comprising a memory and one or more processors coupled to the memory, the one or more processors configured to perform the method of one or more of Aspects 1-16.
Aspect 36: An apparatus for wireless communication, comprising at least one means for performing the method of one or more of Aspects 1-16.
Aspect 37: A non-transitory computer-readable medium storing code for wireless communication, the code comprising instructions executable by a processor to perform the method of one or more of Aspects 1-16.
Aspect 38: A non-transitory computer-readable medium storing a set of instructions for wireless communication, the set of instructions comprising one or more instructions that, when executed by one or more processors of a device, cause the device to perform the method of one or more of Aspects 1-16.
Aspect 39: An apparatus for wireless communication at a device, comprising a processor; memory coupled with the processor; and instructions stored in the memory and executable by the processor to cause the apparatus to perform the method of one or more of Aspects 17-33.
Aspect 40: A device for wireless communication, comprising a memory and one or more processors coupled to the memory, the one or more processors configured to perform the method of one or more of Aspects 17-33.
Aspect 41: An apparatus for wireless communication, comprising at least one means for performing the method of one or more of Aspects 17-33.
Aspect 42: A non-transitory computer-readable medium storing code for wireless communication, the code comprising instructions executable by a processor to perform the method of one or more of Aspects 17-33.
Aspect 43: A non-transitory computer-readable medium storing a set of instructions for wireless communication, the set of instructions comprising one or more instructions that, when executed by one or more processors of a device, cause the device to perform the method of one or more of Aspects 17-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit an indication that the UE is a reduced capability (RedCap) UE associated with a maximum reception bandwidth; and
receive a configuration of one or more common frequency resources (CFRs) associated with one or more broadcast communications, wherein the configuration of the one or more CFRs is based at least in part on the indication that the UE is the RedCap UE associated with the maximum reception bandwidth.

2. The apparatus of claim 1, wherein the configuration of the one or more CFRs configures a single CFR, wherein a bandwidth associated with the single CFR is based at least in part on a bandwidth associated with a control resource set (CORESET).

3. The apparatus of claim 2, wherein the bandwidth associated with the CORESET and the bandwidth associated with the single CFR is less than or equal to the maximum reception bandwidth.

4. The apparatus of claim 1, wherein the configuration of the one or more CFRs configures a first CFR and a second CFR.

5. The apparatus of claim 4, wherein a bandwidth associated with the second CFR is larger than a bandwidth associated with the first CFR, and wherein, based at least in part on the UE being the RedCap UE associated with the maximum reception bandwidth, the bandwidth associated with the first CFR is less than or equal to the maximum reception bandwidth and the UE is configured to monitor the first CFR and not the second CFR.

6. The apparatus of claim 4, wherein a bandwidth associated with the second CFR is larger than a bandwidth associated with the first CFR, and wherein one or more non-RedCap UEs are configured to monitor the first CFR and the second CFR.

7. The apparatus of claim 4, wherein the first CFR is associated with a first broadcast communication, of the one or more broadcast communications, associated with at least one of a first multimedia broadcast multicast service (MBMS) point-to-multipoint control channel (MCCH) or a first MBMS point-to-multipoint traffic channel (MTCH), and wherein the second CFR is associated with a second broadcast communication, of the one or more broadcast communications, associated with at least one of a second MCCH or a second MTCH.

8. The apparatus of claim 4, wherein at least a broadcast communication, of the one or more broadcast communications, is transmitted using both the first CFR and the second CFR.

9. The apparatus of claim 8, wherein the broadcast communication is associated with one or more group radio network temporary identifiers.

10. The apparatus of claim 4, wherein the first CFR is confined within the second CFR.

11. The apparatus of claim 4, wherein the first CFR is associated with a first set of broadcast services associated with a multimedia broadcast multicast service (MBMS) point-to-multipoint traffic channel (MTCH), and wherein the second CFR is associated with a second set of broadcast services associated with the MTCH.

12. The apparatus of claim 11, wherein the first CFR is associated with an MBMS point-to-multipoint control channel (MCCH).

13. The apparatus of claim 12, wherein a configuration of the second CFR is received via the MCCH in the first CFR.

14. The apparatus of claim 11, wherein the one or more processors are further configured to receive an indication of resources associated with a physical downlink shared channel (PDSCH) associated with a first broadcast service, of the first set of broadcast services, wherein the indication is communicated using both a first physical downlink control channel (PDCCH) associated with the first CFR and a second PDCCH associated with the second CFR.

15. The apparatus of claim 14, wherein the UE receives the indication of the resources associated with the PDSCH via the first PDCCH, and wherein a frequency domain resource allocation associated with the PDSCH is scaled to a bandwidth associated with the first CFR.

16. The apparatus of claim 1, wherein the one or more processors are further configured to transmit broadcast reception capability information including an indication of at least one of the maximum reception bandwidth associated with the UE, or a maximum data rate of broadcast services associated with the UE.

17. An apparatus for wireless communication at a network entity, comprising:
a memory; and
one or more processors, coupled to the memory, configured to:
receive, from a user equipment (UE), an indication that the UE is a reduced capability (RedCap) UE associated with a maximum reception bandwidth; and
transmit, to the UE, a configuration of one or more common frequency resources (CFRs) associated with one or more broadcast communications, wherein the configuration of the one or more CFRs is based at least in part on the indication that the UE is the RedCap UE associated with the maximum reception bandwidth.

18. The apparatus of claim 17, wherein the configuration of the one or more CFRs configures a single CFR, wherein a bandwidth associated with the single CFR is based at least in part on a bandwidth associated with a control resource set (CORESET).

19. The apparatus of claim 17, wherein the configuration of the one or more CFRs configures a first CFR and a second CFR.

20. The apparatus of claim 19, wherein a bandwidth associated with the second CFR is larger than a bandwidth associated with the first CFR, and wherein, based at least in part on the UE being the RedCap UE associated with the maximum reception bandwidth, the bandwidth associated with the first CFR is less than or equal to the maximum reception bandwidth and the UE is configured to monitor the first CFR and not the second CFR.

21. The apparatus of claim 19, wherein the one or more processors are further configured to transmit, to one or more non-RedCap UEs, the configuration of one or more CFRs associated with the one or more broadcast communications, wherein a bandwidth associated with the second CFR is larger than a bandwidth associated with the first CFR, and wherein one or more non-RedCap UEs are configured to monitor the first CFR and the second CFR.

22. The apparatus of claim 19, wherein the first CFR is associated with a first broadcast communication associated with at least one of a first multimedia broadcast multicast service (MBMS) point-to-multipoint control channel (MCCH) or a first MBMS point-to-multipoint traffic channel (MTCH), and wherein the second CFR is associated with a second broadcast communication associated with at least one of a second MCCH or a second MTCH.

23. The apparatus of claim 19, wherein the first CFR is associated with a first set of broadcast services associated with a multimedia broadcast multicast service (MBMS) point-to-multipoint traffic channel (MTCH), and wherein the second CFR is associated with a second set of broadcast services associated with the MTCH.

24. The apparatus of claim 23, wherein the first CFR is associated with an MBMS point-to-multipoint control channel (MCCH).

25. The apparatus of claim 24, wherein a configuration of the second CFR is transmitted via the MCCH in the first CFR.

26. A method of wireless communication performed by a user equipment (UE), comprising:
transmitting an indication that the UE is a reduced capability (RedCap) UE associated with a maximum reception bandwidth; and
receiving a configuration of one or more common frequency resources (CFRs) associated with one or more broadcast communications, wherein the configuration of the one or more CFRs is based at least in part on the indication that the UE is the RedCap UE associated with the maximum reception bandwidth.

27. The method of claim 26, wherein the configuration of the one or more CFRs configures a single CFR, and wherein a bandwidth associated with the single CFR is based at least in part on a bandwidth associated with a control resource set (CORESET).

28. The method of claim 26, wherein the configuration of the one or more CFRs configures a first CFR and a second CFR.

29. A method of wireless communication performed by a network entity, comprising:
receiving, from a user equipment (UE), an indication that the UE is a reduced capability (RedCap) UE associated with a maximum reception bandwidth; and
transmitting, to the UE, a configuration of one or more common frequency resources (CFRs) associated with one or more broadcast communications, wherein the configuration of the one or more CFRs is based at least in part on the indication that the UE is the RedCap UE associated with the maximum reception bandwidth.

30. The method of claim 29, wherein the configuration of the one or more CFRs configures a first CFR and a second CFR.
